(19) United States
(12) Patent Application Publication
(10) Pub. No.: US 2021/0280380 A1
(43) Pub. Date: Sep. 9, 2021

(54) SWITCH DEVICE

(71) Applicant: KABUSHIKI KAISHA TOKAI RIKA DENKI SEISAKUSHO, Aichi (JP)

(72) Inventors: Masahiro Kato, Aichi (JP); Nobuyuki Ishigure, Aichi (JP); Yuki Sato, Aichi (JP); Masaki Tsuda, Aichi (JP); Takayuki Aoki, Toyota-shi (JP); Shinji Matsubara, Toyota-shi (JP); Toshihiko Kosugi, Toyota-shi (JP); Ryusuke Ohta, Toyota-shi (JP); Shinji Hara, Aichi (JP)

(21) Appl. No.: 17/189,103

(22) Filed: Mar. 1, 2021

(30) Foreign Application Priority Data
Mar. 4, 2020 (JP) 2020-036772

(51) Int. Cl. H01H 25/04; B60Q 1/14

(52) U.S. Cl. CPC H01H 25/04; B60Q 1/1469

(57) ABSTRACT

A switch device includes a switch body including a switch contact point, a lever unit pivoted about the switch body to switch the switch contact point between different states, and a guard arranged on a lever shaft of the lever unit and shaped to conceal the switch body at the proximal end of the lever shaft. The lever shaft includes a root portion, which is connected to the switch body, and a bent portion, which is bent and extended from the root portion. The guard is shaped so that the distance to a pivotal center of the lever unit is not constant.

### BACKGROUND

### 1. Field

The following description relates to a switch device.

### 2. Description of Related Art

A known lever combination switch having multiple switching functionalities is used as a switch device that is operated to actuate vehicle onboard units (refer to, for example, Japanese Laid-Open Patent Publication No. 2013-157107). Examples of switch functionalities of the lever combination switch include a turn signal switch, a light switch, a dimmer switch, a wiper switch, and a washer switch. The lever combination switch includes a lever unit that controls the switching functionalities and a switch body that supports the lever unit. The switch body is accommodated in, for example, a column cover that covers a steering shaft, and the lever unit projects toward the passenger compartment out of an insertion hole in the column cover.

The lever unit of the switch device may be bent at an angle of attachment into the column cover. In this case, the interior of the column cover is visible through a clearance in the insertion hole in the column cover. This adversely affects aesthetic appeal.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a lever-type switch device includes multiple switching functionalities for operating multiple vehicle onboard units. The switch device includes a switch body including a switch contact point, a lever unit pivoted about the switch body to switch the switch contact point between different states, and a guard arranged on a lever shaft of the lever unit and shaped to conceal the switch body at a proximal end of the lever shaft. The lever shaft includes a root portion, which is connected to the switch body, and a bent portion, which is bent and extended from the root portion. The guard is shaped so that a distance to a pivotal center of the lever unit is not constant.

Other features and aspects will be apparent from the following detailed description, the drawings, and the claims.

### BRIEF DESCRIPTION OF THE DRAWINGS

FIG. 1 is a front view showing an irregularly-shaped steering unit.

FIG. 2 is a side view showing the irregularly-shaped steering unit.

FIG. 3 is a front view showing a switch device.

FIG. 4 is a top view showing the switch device.

FIG. 5 is an exploded perspective view showing the inner portion of a switch body.

FIG. 6 is an exploded perspective view showing a first pivoting unit and a second pivoting unit.

FIG. 7 is a cross-sectional view taken along line VII-VII in FIG. 3.

FIG. 8 is a block diagram showing the electric system of the switch device.

FIG. 9 is a cross-sectional view taken along line IX-IX in FIG. 4.

FIG. 10A is a diagram showing a right turning operation of the irregularly-shaped steering unit.

FIG. 10B is a diagram showing a left turning operation of the irregularly-shaped steering unit.

FIG. 11A is a diagram showing an operation of the switch device.

FIG. 11B is a diagram showing an operation of the switch device.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

A switch device according to one embodiment will now be described with reference to the drawings.

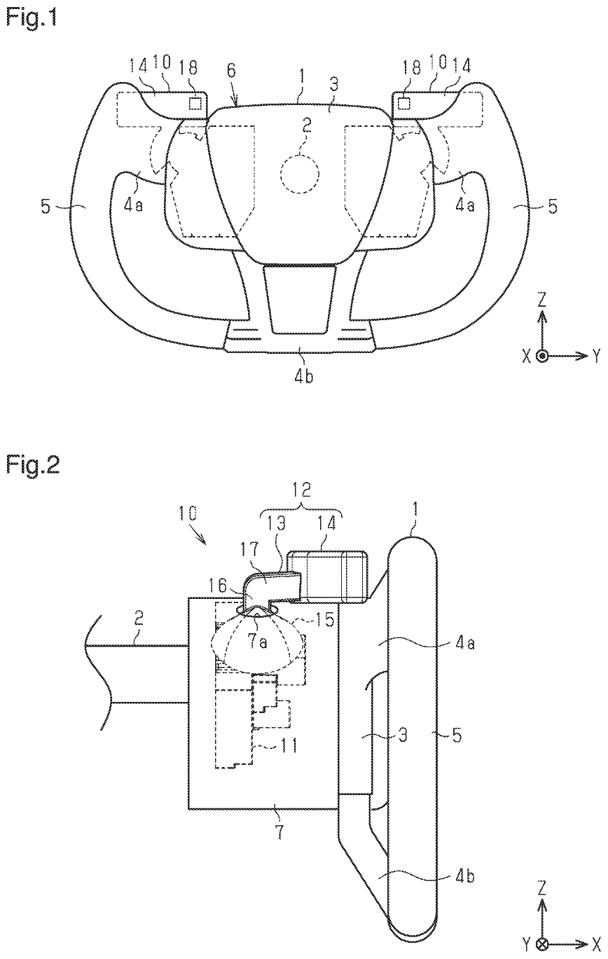

As shown in FIG. 1, an irregularly-shaped steering unit 1 that is operated to steer the vehicle is arranged near a driver's seat. The irregularly-shaped steering unit 1 is rotationally coupled to the vehicle body by a steering shaft 2, which is coaxial with the steering unit 1. The steering shaft 2 corresponds to a rotary shaft of the irregularly-shaped steering unit 1. In the axial direction of the steering shaft 2, the back side is directed toward the vehicle body, and the front side is opposite to the back side. The front side of the irregularly-shaped steering unit 1 is opposed toward a user who performs steering. A width direction and a height direction of irregularly-shaped steering unit 1 are orthogonal to each other and to the axial direction. In FIG. 1, the axial direction, the width direction, and the height direction are indicated as the X-axis direction, the Y-axis direction, and the Z-axis direction, respectively.

The irregularly-shaped steering unit 1 includes a hub 3 connected to the steering shaft 2 and two grips 5 arranged near the hub 3. The irregularly-shaped steering unit 1 also includes two spokes 4a, which are arranged at opposite sides of the hub 3 in the width direction of the irregularly-shaped steering unit 1, and a spoke 4b, which is arranged at the lower side of the hub 3 in the height direction of the irregularly-shaped steering unit 1. In one example, the irregularly-shaped steering unit 1 includes the two spokes 4a coupled to the two ends of the hub 3 in the width direction of the irregularly-shaped steering unit 1 and the spoke 4b coupled to the lower end of the hub 3 in the height direction of the irregularly-shaped steering unit 1. The spokes 4a and the spoke 4b connect the hub 3 and the grips 5.

The hub 3, the spokes 4a, the spoke 4b, and the two grips 5 form a peripheral portion 6 of the irregularly-shaped steering unit 1. The peripheral portion 6 defines the contour of the irregularly-shaped steering unit 1 in a front axial view. The peripheral portion 6 of the present embodiment is longer in the width direction and shorter in the height direction. In this manner, the irregularly-shaped steering unit 1 is a steering wheel having dimensions that differ in the width direction and the height direction when viewed in the axial direction. That is, the irregularly-shaped steering unit 1 has a shape that is noncircular. The irregularly-shaped steering unit 1 may be shaped to be elliptic.

The two grips 5 of the present embodiment are arranged at opposite sides of the irregularly-shaped steering unit 1 in the width direction. The two grips 5 form a non-annular shape that does not include an upper portion and a lower portion in the height direction. The grips 5 are connected by the spoke 4b to the lower side of the hub 3. The hub 3 and the spoke 4b form the lower part of the peripheral portion 6. The upper sides of the grips 5 are connected to the hub 3 by the spokes 4a. The hub 3, the spokes 4a, and the grips 5 form the upper part the peripheral portion 6. The grips 5 at opposite sides of the peripheral portion 6 in the width direction form the side parts of the peripheral portion 6. In one example, a first end of each grip 5 is coupled to the corresponding one of the spokes 4a, and a second end of each grip 5 is coupled to the spoke 4b.

Two switch devices 10 that are operated to actuate vehicle onboard units are arranged proximate to the irregularly-shaped steering unit 1. The switch devices 10 are arranged in a substantially symmetrical manner at a back side of the irregularly-shaped steering unit 1. Each switch device 10 is used to operate multiple vehicle onboard units. Examples of the vehicle onboard units include a turn signal device, a light device, a fog lamp device, a front wiper device, a rear wiper device, and a mist washer device. The axial direction, the width direction, and the height direction of the irregularly-shaped steering unit 1 correspond to the axial direction, the width direction, and the height direction of each switch device 10.

As shown in FIG. 2, the irregularly-shaped steering unit 1 includes a cover member 7 at the back side of the hub 3. The cover member 7 is, for example, hollow and surrounds the steering shaft 2. Further, the cover member 7 forms the rear shell of the irregularly-shaped steering unit 1.

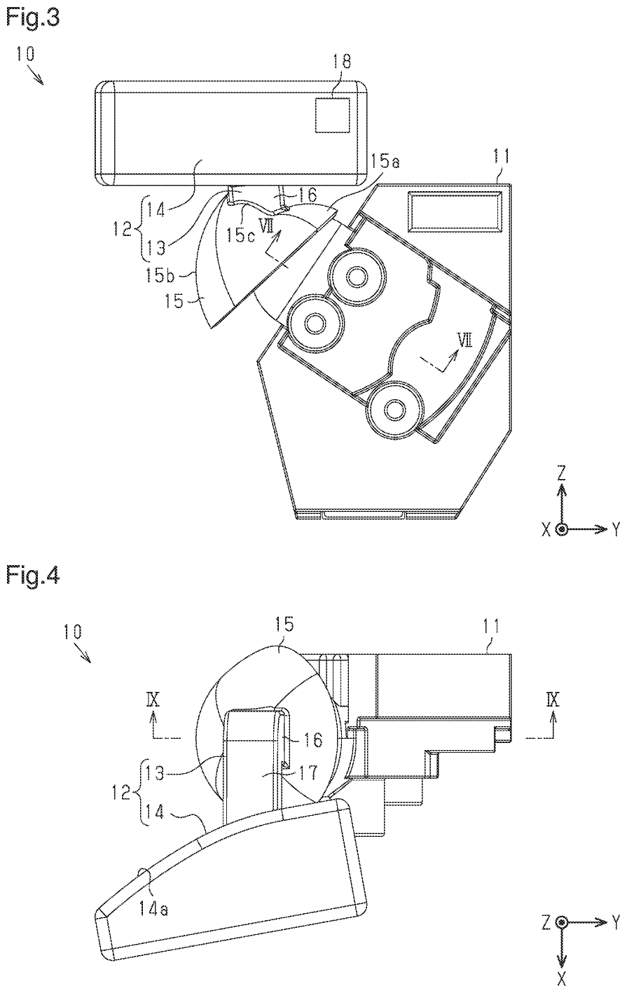

As shown in FIGS. 2 and 3, the switch device 10 includes a switch body 11, which is attached to and rotatable integrally with the irregularly-shaped steering unit 1, and a lever unit 12, which is held pivotally about the switch body 11. The switch body 11 is accommodated in the cover member 7. The lever unit 12 projects out of an insertion hole 7a, which extends through the cover member 7, in the radial direction of the steering shaft 2. The lever unit 12 is arranged to pivot about the switch body 11 and the irregularly-shaped steering unit 1. The lever unit 12 is assigned a switching functionality that switches contact points. The insertion hole 7a has a greater diameter than the lever unit 12 to allow the lever unit 12 to be pivoted.

The lever unit 12 includes a lever shaft 13 extending from the switch body 11 and a hammer-shaped lever head 14 connected to the switch body 11 by the lever shaft 13. A guard 15 is arranged around the lever shaft 13 to cover the switch body 11. In one example, the lever unit 12 includes the guard 15 arranged around the end of the lever shaft 13 that is closer to the switch body 11. In one example, part of the guard 15 is accommodated in the cover member 7 and another part of the guard 15 is positioned in the insertion hole 7a. The guard 15 is umbrella-shaped and open toward the switch body 11. The umbrella-shaped portion of the guard 15 has a greater diameter than the insertion hole 7a of the cover member 7.

The lever shaft 13 includes a base 16, which is connected to the switch body 11 and projects upward from the switch body 11, and an arm 17, which extends in the axial direction from the base 16. Accordingly, the lever shaft 13 is bent at a position located radially outward from the cover member 7. The guard 15 is arranged over a region extending about the axis of the base 16. The arm 17 extends along the cover member 7 from the back side toward the front side of the irregularly-shaped steering unit 1. The lever head 14 is arranged at the end of the front side of the arm 17.

As shown in FIGS. 3 and 4, the lever head 14 extends from the lever shaft 13 in a direction that intersects the axial direction. In other words, the arm 17 of the lever shaft 13 and the lever head 14 intersect each other in a substantially T-shaped manner. The lever head 14 of the present embodiment extends from the lever shaft 13 in the width direction of the irregularly-shaped steering unit 1. The lever head 14 is shaped to be larger than the diameter of the lever shaft 13. The diameter of the lever shaft 13 is, for example, the dimension of the lever shaft 13 in the direction that intersects the direction in which the lever shaft 13 extends. The lever head 14 extends further in the radial direction of the steering shaft 2 than the lever shaft 13.

The lever head 14 extends away from the steering shaft 2 in the width direction of the irregularly-shaped steering unit 1. More specifically, the lever head 14 is inclined so that the outward portion in the width direction is located frontward from the inward portion with respect to the axial direction. Further, the lever head 14 is arranged diagonally relative to the axial direction, and a back surface 14a of the lever head 14 is narrowed outward in the width direction of the lever head 14 with respect to the axial direction.

As shown in FIG. 1, the lever units 12 do not project outward from the peripheral portion 6 of the irregularly-shaped steering unit 1 in the width direction. The lever units 12 project outward from the peripheral portion 6 in the height direction. The lever units 12 of the present embodiment project upward and outward from the upper part of the peripheral portion 6 in the height direction. The lever units 12 are arranged downward from the upper ends of the grips 5. That is, the lever units 12 are formed so as not to extend outward from the grips 5 but are partially exposed to the front side of the irregularly-shaped steering unit 1.

As described above, the lever heads 14 are partially exposed to the front side of the irregularly-shaped steering unit 1 in the axial direction. The lever heads 14 each include a display 18 that displays the switching functionality on an exposed front surface. The display 18 displays, for example, an operation direction for the turn signal device or the wiper device.

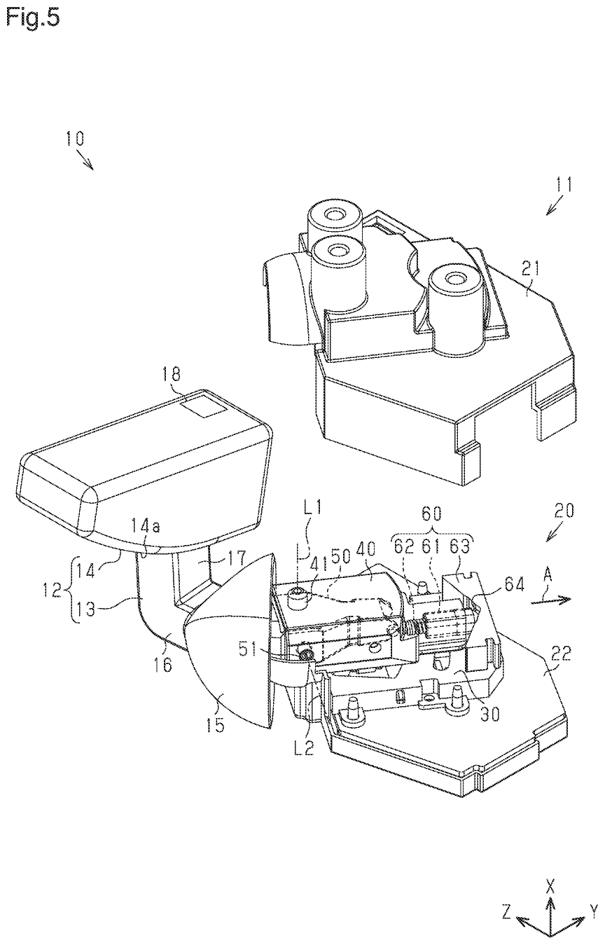

As shown in FIG. 5, the switch body 11 includes an upper case 21 and a lower case 22 that are opposed toward each other in the axial direction of the steering shaft 2. In a state in which the upper case 21 is attached to the irregularly-shaped steering unit 1, the upper case 21 is arranged at the front side in the axial direction. The lower case 22 is arranged at the back side in the axial direction. The upper case 21 and the lower case 22 accommodate a switch mechanism 20 that supports the lever unit 12 in a pivotal manner.

As shown in FIGS. 5 to 7, the switch mechanism 20 includes a base unit 30 engaged with the lower case 22, a first pivoting unit 40 supported by the upper case 21, and a second pivoting unit 50 pivotally supported about the first pivoting unit 40. The switch mechanism 20 is connected to the lever unit 12 in a connection direction A, and the first pivoting unit 40 and the second pivoting unit 50 are arranged to extend in the connection direction A. In the present embodiment, the connection direction A is orthogonal to the axial direction and extends diagonally relative to the width direction and the height direction. The switch mechanism 20 supports the lever unit 12 pivotally about two directions that are orthogonal to the connection direction A.

The first pivoting unit 40 includes a projection 41 projecting toward the upper case 21. The upper case 21 includes a fitting hole 21a into which the projection 41 is fitted. The first pivoting unit 40 and the second pivoting unit 50 are supported by the upper case 21 pivotally about a first axis L1 by fitting the projection 41 to the fitting hole 21a. The first axis L1 extends in the axial direction of the steering shaft 2. The first axis L1 corresponds to “the pivotal axis” of the lever unit 12.

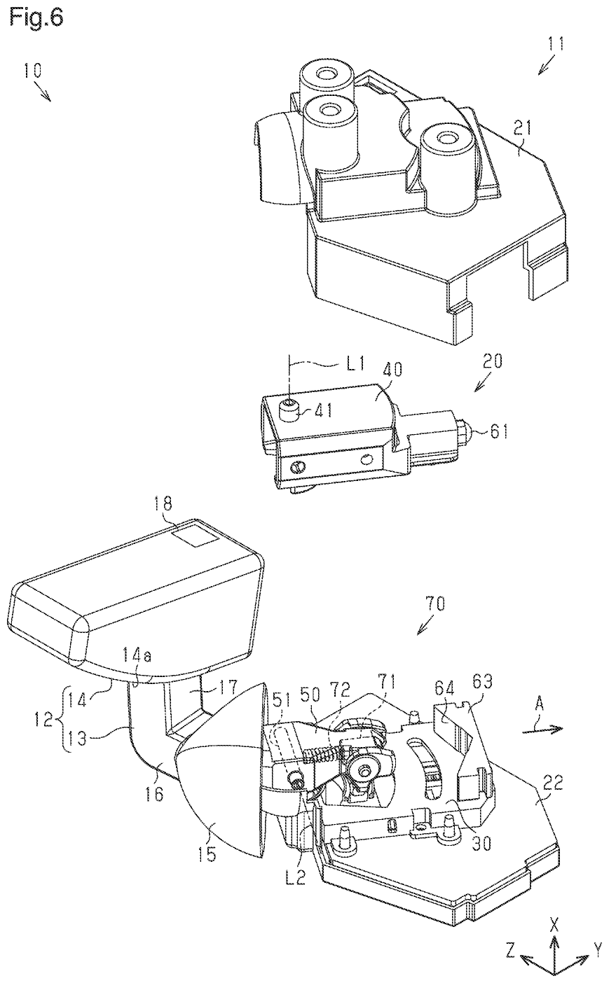

As shown in FIGS. 5 and 6, the second pivoting unit 50 is fitted into and coupled to the first pivoting unit 40. The proximal side of the second pivoting unit 50 is connected to the base 16 of the lever shaft 13 in the connection direction A. In one example, the proximal end of the second pivoting unit 50 is connected to the base 16 of the lever shaft 13. A through shaft 51 extends through the first pivoting unit 40 and the second pivoting unit 50. The through shaft 51 pivotally supports the second pivoting unit 50 on the first pivoting unit 40. The through shaft 51 is arranged at the proximal side of the second pivoting unit 50 in the connection direction A. In one example, the through shaft 51 extends along a second axis L2 at the proximal end of the second pivoting unit 50. Accordingly, the second pivoting unit 50 is supported by the first pivoting unit 40 pivotally about the second axis L2. The second axis L2 is orthogonal to the first axis L1.

As shown in FIG. 5, the switch mechanism 20 includes a detent mechanism 60 at the distal side of the first pivoting unit 40 in the connection direction A. The detent mechanism 60 produces resistance when the lever unit 12 is operated. In one example, the detent mechanism 60 is arranged at the distal end of the first pivoting unit 40. The detent mechanism 60 includes an abutment portion 61 that projects out of the distal end of the first pivoting unit 40 and an urging member 62 that urges the abutment portion 61 toward the distal side in the connection direction A. The detent mechanism 60 also includes an opposing wall 63 arranged on the base unit 30 and opposed toward the abutment portion 61. The surface of the opposing wall 63 opposed toward the abutment portion 61 is inclined and recessed in the connection direction A of the first pivoting unit 40 and defines an inclined surface 64. The inclined surface 64 is inclined to form a substantially triangular shape. The abutment portion 61 is urged by the urging member 62 against the opposing wall 63. The detent mechanism 60 produces resistance when the lever unit 12 is operated about the first axis L1.

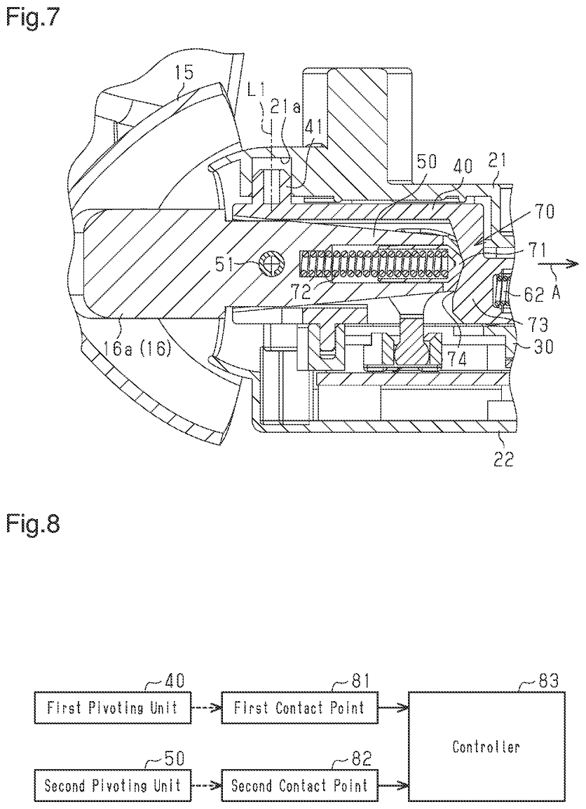

As shown in FIGS. 6 and 7, the switch mechanism 20 includes a detent mechanism 70 at the distal side of the second pivoting unit 50 in the connection direction A. The detent mechanism 70 produces resistance when the lever unit 12 is operated. In one example, the detent mechanism 70 is arranged at the distal end of the second pivoting unit 50. The detent mechanism 70 includes an abutment portion 71 that is arranged at the distal end of the second pivoting unit 50 and an urging member 72 that urges the abutment portion 71 toward the distal side in the connection direction A. The detent mechanism 70 also includes an opposing wall 73 arranged inside the first pivoting unit 40 and opposed toward the abutment portion 71. The surface of the opposing wall 73 opposed toward the abutment portion 71 defines an inclined surface 74 inclined in a direction orthogonal to the inclined surface 64 of the detent mechanism 60. The detent mechanism 70 produces resistance when the lever unit 12 is operated about the second axis L2.

As described above, the lever unit 12 is supported on the switch body 11 pivotally about the first axis L1 and the second axis L2 by the first pivoting unit 40 and the second pivoting unit 50 of the switch mechanism 20. When the lever unit 12 is operated to pivot about the second axis L2, only the second pivoting unit 50 is pivoted and the first pivoting unit 40 is not pivoted. When the lever unit 12 is operated to pivot about the first axis L1, the first pivoting unit 40 and the second pivoting unit 50 are pivoted. The lever unit 12, when operated to pivot about the first axis L1, pivots about the axis of the steering shaft 2 and, when operated to pivot about the second axis L2, pivots about a direction that intersects the axis of the steering shaft 2.

As shown in FIG. 8, the switch device 10 includes a first contact point 81 that is operated by the first pivoting unit 40, a second contact point 82 that is operated by the second pivoting unit 50, and a controller 83 that controls switching functionalities. The first contact point 81 and the second contact point 82 correspond to switch contact points.

The first contact point 81 is switched between open and closed states when the first pivoting unit 40 is pivoted about the first axis L1. The second contact point 82 is switched between open and closed states when the second pivoting unit 50 is pivoted about the second axis L2. The controller 83 controls the functionalities of vehicle onboard units that are assigned to the first contact point 81 and the second contact point 82 based on the open and closed states of the first contact point 81 and the second contact point 82. This activates or deactivates the switching functionalities in accordance with the operation directions of the lever unit 12.

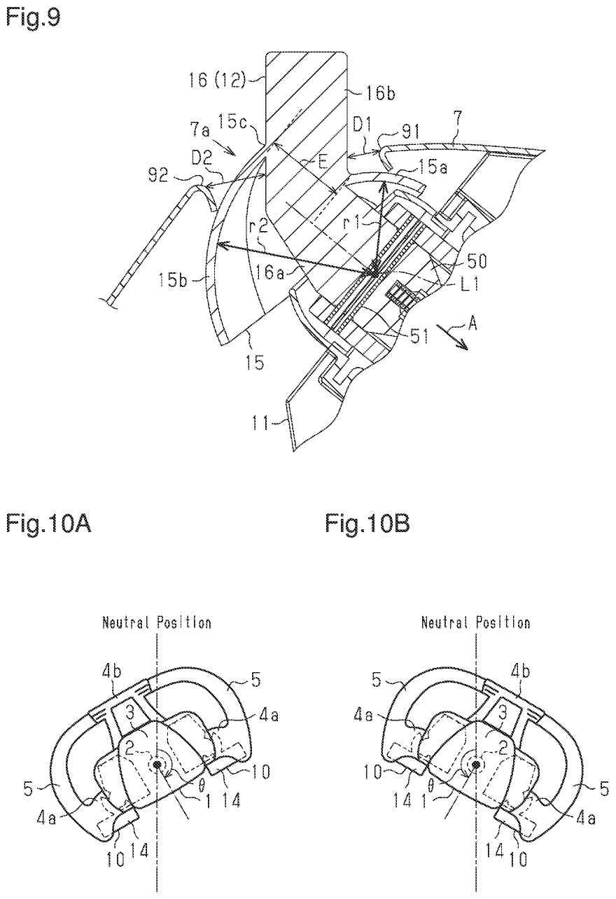

As shown in FIG. 9, the base 16 of the lever shaft 13 includes a root portion 16a connected to the second pivoting unit 50 and a bent portion 16b bent and extended from the root portion 16a. The root portion 16a extends in the connection direction A along the second pivoting unit 50. The bent portion 16b extends upward in the height direction. In this manner, the base 16 is shaped so as to be bent with respect the connection direction A toward a direction extending about the steering shaft 2. The bent portion 16b extends through the insertion hole 7a of the cover member 7 and projects out of the cover member 7.

The insertion hole 7a extends diagonally relative to the connection direction A. The insertion hole 7a provides clearance between the cover member 7 and the base 16 to allow the lever unit 12 to be pivoted. The cover member 7 of the present embodiment is spaced apart from the base 16 by a distance that differs between the bent-direction side of the base 16 and a side opposite to the bent-direction side to allow for pivoting about the axis of the steering shaft 2. Specifically, an edge of the insertion hole 7a in the cover member 7 includes a first edge portion 91 that is separated from the base 16 by distance D1 and a second edge portion 92 that is separated from the base 16 by distance D2, which is greater than distance DE In this case, the bent-direction side of the base 16 is closer to the first edge portion 91 and the side opposite to the bent-direction side is closer to the second edge portion 92. In the present embodiment, the edge of the insertion hole 7a in the cover member 7 is spaced apart from the base 16 by the same distance at the front side and the back side in the axial direction.

The guard 15 around the base 16 includes a first arcuate portion 15a arranged closer to the first edge portion 91 and a second arcuate portion 15b arranged closer to the second edge portion 92. The guard 15 also includes a guard root 15c coupled to the base 16. The first arcuate portion 15a and the second arcuate portion 15b in a cross section are arcuate and extend about the intersection point of the first axis L1 and the second axis L2 that serves as a pivotal center. The first arcuate portion 15a has radius r1 about the first axis L1. The second arcuate portion 15b has radius r2, which is greater than radius r1, about the first axis L1.

The guard root 15c includes a step E between the first arcuate portion 15a and the second arcuate portion 15b. The step E of the guard root 15c corresponds to the distance between the first arcuate portion 15a and the second arcuate portion 15b in the connection direction A. In the guard root 15c, the second arcuate portion 15b is arranged closer to the distal end of the lever unit 12 than the first arcuate portion 15a. Specifically, the portion of the guard root 15c at the side opposite to the bent-direction side of the base 16 is arranged closer to the distal end of the lever unit 12 than the portion of the guard root 15c at the bent-direction side. In this manner, the guard 15 is shaped in a manner in which the distance to the pivotal center of the lever unit 12 is not constant in order to obtain the step E around the base 16. In the present embodiment, the step E is equal to the difference between radius r1 and radius r2. The guard 15 is curved between the first arcuate portion 15a and the second arcuate portion 15b so that the guard 15 is umbrella-shaped in its entirety. Specifically, the guard 15 includes a curved portion arranged between the first arcuate portion 15a and the second arcuate portion 15b and connecting the first arcuate portion 15a and the second arcuate portion 15b.

The operation of the present embodiment will now be described.

As shown in FIGS. 10A and 10B, the irregularly-shaped steering unit 1 can be turned rightward and leftward from a neutral position. FIG. 10 is a diagram showing the irregularly-shaped steering unit 1 turned rightward from the neutral position, and FIG. 10B is a diagram showing the irregularly-shaped steering unit 1 turned leftward from the neutral position. The irregularly-shaped steering unit 1 of the present embodiment cannot be rotated rightward or leftward from the neutral position more than one full rotation. That is, the irregularly-shaped steering unit 1 has a rotation angle limit that allows for less than a single rotation in the rightward and leftward directions. Preferably, the maximum rotation angle θ of the irregularly-shaped steering unit 1 is, for example, approximately 150 to 160 degrees.

The switch device 10 according to the present embodiment is attached to the irregularly-shaped steering unit 1 and rotated integrally with the irregularly-shaped steering unit 1. Thus, the positional relationship of the irregularly-shaped steering unit 1 and the switch device 10 is always the same regardless of the position of the irregularly-shaped steering unit 1.

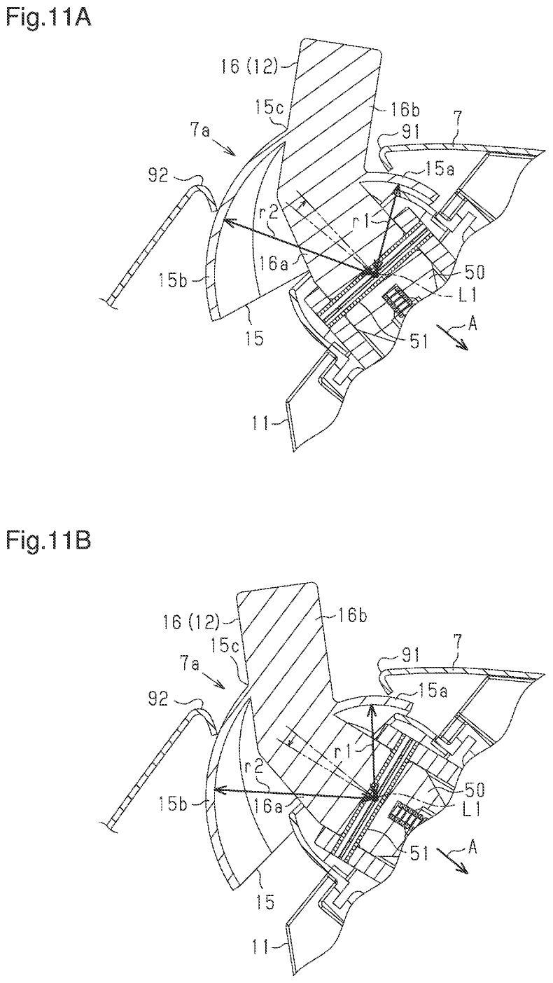

As shown in FIG. 11A, when the lever unit 12 is pivoted rightward about the first axis L1, the guard 15 is rotated together with the lever unit 12 in a circumferential direction about the first axis L1. In this case, the distance between the first edge portion 91 and the lever unit 12 decreases, and the distance between the second edge portion 92 and the lever unit 12 increases. The first arcuate portion 15a moves beneath the cover member 7, and the second arcuate portion 15b is moved and exposed from the insertion hole 7a of the cover member 7. After being moved, the first arcuate portion 15a and the second arcuate portion 15b continue to close the clearance in the insertion hole 7a and conceal the interior of the cover member 7.

As shown in FIG. 11B, in the same manner, when the lever unit 12 is pivoted leftward about the first axis L1, the guard 15 is rotated together with the lever unit 12 in the circumferential direction about the first axis L1. In this case, the distance between the second edge portion 92 and the lever unit 12 decreases, and the distance between the first edge portion 91 and the lever unit 12 increases. After being moved, the first arcuate portion 15a and the second arcuate portion 15b also close the clearance in the insertion hole 7a.

The base 16 of the lever unit 12 is bent so that the size of the clearance between the lever unit 12 and the cover member 7 differs between the right side and the left side about the first axis L1, that is, the first edge portion 91 and the second edge portion 92. In the present embodiment, the guard 15 includes the step E around the lever unit 12 and is shaped so that the distance to the pivotal center is not constant. This closes the clearance between the lever unit 12 and the cover member 7 at the right side and the left side.

The first arcuate portion 15a and the second arcuate portion 15b extend about the pivotal center on the first axis L1. Thus, when the lever unit 12 is pivoted about the first axis L1, the clearance between the edge of the insertion hole 7a and the guard 15 does not change. This restricts the formation of a gap between the edge of the insertion hole 7a and the guard 15 regardless of pivotal position.

Further, the first edge portion 91 and the second edge portion 92 are separated by different distances from the first axis L1. The first arcuate portion 15a is set to have radius r1, and the second arcuate portion 15b is set to have radius r2. This reduces the clearance between each edge portion and the guard 15.

The advantages of the present embodiment will now be described.

(1) The switch device 10 includes a switch body 11 that includes the first contact point 81 and the second contact point 82, and a lever unit 12 pivoted about the switch body 11 to switch the first contact point 81 and the second contact point 82 between different states. The switch device 10 also includes the guard 15 arranged on the lever shaft 13 of the lever unit 12 and shaped to conceal the switch body 11 at the proximal end of the lever shaft 13. The lever shaft 13 includes a root portion 16a, which is connected to the switch body 11, and the bent portion 16b, which is bent and extended from the root portion 16a. The guard 15 is shaped so that the distance to the pivotal center of the lever unit 12 is not constant. With this structure, even though the clearance between the lever unit 12 and the cover member 7 covering the switch body 11 is not uniform, the guard 15 is shaped in conformance with the clearance. Specifically, the guard 15, which is shaped in conformance with the bent lever unit 12, covers and conceals the switch body 11. This improves aesthetic appeal.

(2) The guard 15 is arranged over a region extending about the axis of the lever shaft 13. This structure closes the clearance extending over the region about the lever shaft 13 and improves aesthetic appeal.

(3) The guard 15 includes the guard root 15c coupled to the lever shaft 13. The portion of the guard root 15c at the side opposite to the bent-direction side of the lever shaft 13 is arranged closer to the distal end of the lever shaft 13 than the portion of the guard root 15c at the bent-direction side. With this structure, the guard 15 is shaped in conformance with the bent-direction side of the lever shaft 13. This easily closes the clearance and improves aesthetic appeal.

(4) The guard 15 is umbrella-shaped and open toward the switch body 11. With this structure, the guard 15 is suitably shaped to conceal the switch body 11 from the outer side of the cover member 7.

(5) The lever unit 12 is pivoted in a direction extending about the axis of the steering shaft 2. This structure improves the aesthetic appeal of the switch device 10, which is operated about the axis.

(6) The lever unit 12 is pivoted about the first axis L1 extending through the switch body 11. In a cross-sectional view orthogonal to the first axis L1, the guard 15 includes the first arcuate portion 15a and the second arcuate portion 15b that extend about the first axis L1 and differ from each other in radius. When the lever unit 12 is pivoted about the first axis L1, the arcuate guard 15 restricts the formation of a gap between the edge of the insertion hole in the cover member 7 and the guard 15. This improves aesthetic appeal. Further, radius r1 of the first arcuate portion 15a is set in accordance with the distance D1 between the first edge portion 91 of the insertion hole 7a and the lever unit 12, and radius r2 of the second arcuate portion 15b is set in accordance with the distance D2 between the second edge portion 92 of the insertion hole 7a and the lever unit 12. This restricts the formation of a gap between the cover member 7 and the guard 15.

(7) The switch body 11 is rotatable integrally with the irregularly-shaped steering unit 1. With this structure, the switch body 11 can be applied to the switch device 10 that is rotated integrally with the irregularly-shaped steering unit 1.

(8) The switch body 11 is accommodated in the cover member 7 formed to surround and cover the steering shaft 2. The lever unit 12 is drawn out of the cover member 7 through the insertion hole 7a extending through the cover member 7. The guard 15 conceals the interior of the cover member 7 in the clearance between the insertion hole 7a of the cover member 7 and the lever shaft 13. With this structure, the guard 15, which is arranged on the lever unit 12, conceals the interior of the cover member 7. This improves aesthetic appeal.

The present embodiment may be modified as follows. The present embodiment and the following modifications can be combined as long as the combined modifications are not in contradiction.

Guard 15

The first arcuate portion 15a and the second arcuate portion 15b do not need to be coaxial. Further, the first arcuate portion 15a and the second arcuate portion 15b may have the same radius.

The guard 15 does not need to have an arcuate cross section.

The guard 15 does not need to be umbrella-shaped. Instead, the guard 15 may have any of various shapes.

The step of the guard 15 is not limited to the present embodiment. The step may correspond to a distance in the direction in which the bent portion 16b extends. That is, the guard 15 is not limited to the shape of the present embodiment. The guard 15 only needs to be shaped so that the distance to the pivotal center to the lever unit 12 is not constant.

The pivotal center does not need to be the intersection point of the first axis L1 and the second axis L2. Instead, the pivotal center may be located at any point on the first axis L1 or the second axis L2. Further, the first axis L1 and the second axis L2 may be arranged without intersecting each other at an intersection point and so that one extends over the other.

Switch Body 11

The switch mechanism 20 of the switch body 11 may be arranged to produce resistance against an operation of the lever unit 12.

The switch body 11 may support the lever unit 12 of a momentary type or a stationary type.

The switch body 11 does not need to be covered by the cover member 7 of the irregularly-shaped steering unit 1. Instead, the switch body 11 may be covered by, for example, a cover of the vehicle such as a column cover. Alternatively, the switch body 11 may form part of the rear shell of the irregularly-shaped steering unit 1. The upper case 21 and the lower case 22 may be arranged to cover the guard 15 while forming part of the rear shell of the irregularly-shaped steering unit 1.

Lever Unit 12

The lever head 14 is not limited to the shape of the present embodiment. For example, the back surface 14a does not need to be arranged diagonally relative to the axial direction. However, the lever head 14, which is narrowed in the axial direction at the outer side in the width direction, is advantageous in that the lever head 14 when rotated is less likely to hit a leg or the like of the user.

The lever head 14 may include a switching functionality such as a push button that is operated differently from a pivotal operation.

The lever head 14 may include multiple displays 18. For example, the lever head 14 may include one, two, three, or more displays 18. The display 18 does not need to be arranged on an exposed front portion of the lever head 14. The display 18 may be arranged on the top surface of the lever head 14.

The lever head 14 does not need to include the display 18.

The lever head 14 may extend in the same direction as the operation directions for the lever unit 12 such as the axial direction or the height direction. That is, the lever head 14 may be shaped to be larger than the diameter of the lever shaft 13. The diameter of the lever shaft 13 is, for example, the dimension of the lever shaft 13 in the direction that intersects the direction in which the lever shaft 13 extends.

The arm 17 of the lever shaft 13 does not need to extend from the back side toward the front side in the axial direction. Instead, the lever shaft 13 may extend from the front side toward the back side.

The lever unit 12 does not need to be arranged at the back side of the irregularly-shaped steering unit 1. Instead, the lever unit 12 may be arranged at any other location such as on a side surface or a front surface.

The lever unit 12 may project in the longitudinal direction of the irregularly-shaped steering unit 1 in a front view.

The lever unit 12 may be arranged at any position in the circumferential direction about the irregularly-shaped steering unit 1.

The connection direction A of the lever unit 12 and the switch body 11 is not limited to the present embodiment. The connection direction A may extend in the radial direction of the steering shaft 2.

The base 16 is not limited to the bent shape of the present embodiment. The base 16 may be bent in the width direction from the connection direction A.

The lever unit 12 does not need to be pivoted about two pivotal axes, namely, the first axis L1 and the second axis L2. Instead, the lever unit 12 may be pivotal about a single pivotal axis. Alternatively, the lever unit 12 may be pivotal in a three-dimensional manner about a single pivotal center.

### OTHERS

The irregularly-shaped steering unit 1 does not need to include two switch devices 10. Instead, the irregularly-shaped steering unit 1 may include, for example, one switch device 10 or three or more switch devices 10.

The switch device 10 may be arranged at only one side of the irregularly-shaped steering unit 1. That is, the switch devices 10 do not need to be arranged in a symmetrical manner.

The steering unit is not limited to the irregularly-shaped steering unit 1. The steering unit may be a circular steering unit.

The switch device 10 does not need to be arranged integrally with the steering unit. Instead, the switch device 10 may be arranged to move relative to the steering unit in the same manner as a known lever combination switch.

The various types of switching functionalities of the switch device 10 may include functionalities other than those described in the embodiment.

Switching of various types of switching functionalities may use various types of switches such as a tactile switch and a toggle switch. That is, there is particularly no limitation to the first contact point 81 and the second contact point 82. The various types of switches may include sensors.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A lever-type switch device including multiple switching functionalities for operating multiple vehicle onboard units, the switch device comprising:
a switch body including a switch contact point;
a lever unit pivoted about the switch body to switch the switch contact point; and
a guard arranged on a lever shaft of the lever unit and shaped to conceal the switch body at a proximal end of the lever shaft, wherein
the lever shaft includes a root portion, which is connected to the switch body, and a bent portion, which is bent and extended from the root portion, and
the guard is shaped so that a distance to a pivotal center of the lever unit is not constant.

2. The switch device according to claim 1, wherein the guard is arranged over a region extending about the axis of the lever shaft.

3. The switch device according to claim 1, wherein
the guard includes a guard root coupled to the lever shaft, and
a portion of the guard root at a side opposite to a bent-direction side of the lever shaft is arranged closer to a distal end of the lever unit than a portion of the guard root at the bent-direction side of the lever shaft.

4. The switch device according to claim 1, wherein the guard is umbrella-shaped and open toward the switch body.

5. The switch device according to claim 1, wherein the lever unit is pivoted in a direction extending about an axis of a rotary shaft of the steering unit that is operated to steer a vehicle.

6. The switch device according to claim 1, wherein
the lever unit is pivoted about a pivotal axis extending through the switch body, and
in a cross-sectional view orthogonal to the pivotal axis, the guard includes a first arcuate portion and a second arcuate portion that extend about the pivotal axis and differ from each other in radius.

7. The switch device according to claim 1, wherein the switch body is rotatable integrally with a steering unit that is operated to steer a vehicle.

8. The switch device according to claim 1, wherein
the switch body is accommodated in a cover member formed to surround and cover a rotary shaft of the steering unit that is operated to steer a vehicle,
the lever unit is drawn out of the cover member through an insertion hole extending through the cover member, and
the guard conceals an interior of the cover member in a clearance between the insertion hole of the cover member and the lever shaft.
